(19) United States
(12) Patent Application Publication
(10) Pub. No.: US 2025/0266620 A1
(43) Pub. Date: Aug. 21, 2025

(54) ANTENNA APPARATUS

(71) Applicant: Alps Alpine Co., Ltd., Tokyo (JP)

(72) Inventors: Yuanzhu DOU, Miyagi-ken (JP); Naoki ITO, Miyagi-ken (JP); Tomotaka SUZUKI, Miyagi-ken (JP)

(21) Appl. No.: 19/199,696

(22) Filed: May 6, 2025

Related U.S. Application Data
(63) Continuation of application No. PCT/JP2023/036405, filed on Oct. 5, 2023.

(30) Foreign Application Priority Data
Dec. 15, 2022 (JP) 2022-200579

(51) Int. Cl. H01Q 15/02; H01Q 17/00

(52) U.S. Cl. CPC H01Q 15/02; H01Q 17/00

(57) ABSTRACT

An antenna apparatus includes a board, an integrated circuit chip including a transmitting antenna and a receiving antenna and mounted on the board, a waveguide having a first aperture provided on the board side and surrounding the transmitting antenna and the receiving antenna in aperture view, a second aperture provided on a rear side with respect to the first aperture in a radiation direction of the transmitting antenna, and a first inner wall surface connecting the first aperture and the second aperture, a radio wave lens fixed to the second aperture, and a first radio wave absorber disposed on the first aperture side in a space surrounded by the first inner wall surface. At least part of the first radio wave absorber is located inside a first path of a first direct wave, and the first radio wave absorber is located outside a second path of a second direct wave.

### CLAIM OF PRIORITY

This application is a Continuation of International Application No. PCT/JP2023/036405 filed on Oct. 5, 2023, which claims benefit of Japanese Patent Application No. 2022-200579 filed on Dec. 15, 2022. The entire contents of each application noted above are hereby incorporated by reference.

### BACKGROUND OF THE INVENTION

### 1. Field of the Invention

The present disclosure relates to an antenna apparatus.

### 2. Description of the Related Art

A known lens antenna includes a first horn (conical horn) comprising a metal conductor, a second horn comprising a plastic material having radio wave absorption properties, and a lens that controls power distribution at an aperture of the second horn. The inner wall of the first horn has no radio wave absorber attached; therefore, nothing shields the microwaves nor does it affect the power density distribution at the lens aperture (see Japanese Unexamined Patent Application Publication No. 10-284931, for example).

If the antenna gain is increased to improve the receiver sensitivity in transmitting and receiving radio waves, in some cases, Equivalent Isotropically Radiated Power (EIRP) of radio waves in transmission may exceed the upper limit of EIRP regulated by the Radio Law or other regulations, whereas if the antenna gain is decreased to suppress the increase in EIRP, sufficient receiver sensitivity may not be achieved.

### SUMMARY OF THE INVENTION

An antenna apparatus capable of suppressing an increase in EIRP and achieving good receiver sensitivity is provided.

An antenna apparatus according to an aspect of the disclosure includes a board, an integrated circuit chip including a transmitting antenna and a receiving antenna, the integrated circuit chip being mounted on the board, a waveguide having a first aperture provided on the board side and surrounding the transmitting antenna and the receiving antenna in aperture view, a second aperture provided on a rear side with respect to the first aperture in a radiation direction of the transmitting antenna, and a first inner wall surface connecting the first aperture and the second aperture, a radio wave lens fixed to the second aperture, and a first radio wave absorber disposed on the first aperture side in a space surrounded by the first inner wall surface. At least part of the first radio wave absorber is located inside a first path of a first direct wave that is radiated from the transmitting antenna, directly reaches the radio wave lens, and passes through the radio wave lens, and the first radio wave absorber is located outside a second path of a second direct wave that passes through the radio wave lens and directly reaches the receiving antenna.

### BRIEF DESCRIPTION OF THE DRAWINGS

FIG. 1A is a schematic view of an antenna apparatus according to an embodiment;

FIG. 1B is a schematic view of an antenna apparatus according to an embodiment;

FIG. 1C is a schematic view of an antenna apparatus according to an embodiment;

FIG. 1D is a perspective view of a radio wave absorber in an antenna apparatus according to an embodiment;

FIG. 2A is a cross-sectional view taken along line IIA-IIA, IID-IID in FIG. 1A;

FIG. 2B is a schematic view of an example location of an inner wall surface of a radio wave absorber in an antenna apparatus according to an embodiment;

FIG. 2C is a schematic view of a radio wave absorber absorbing reflected waves in an antenna apparatus according to an embodiment;

FIG. 2D is a schematic view of an example of a first path and a second path in the cross-sectional view taken along line IIA-IIA, IID-IID in FIG. 1A;

FIG. 3A illustrates an example of radiation characteristics of a comparative antenna apparatus;

FIG. 3B illustrates an example of radiation characteristics of a comparative antenna apparatus;

FIG. 3C illustrates an example of radiation characteristics of an antenna apparatus 100 according to an embodiment;

FIG. 3D illustrates an example of radiation characteristics of the antenna apparatus 100 according to the embodiment;

FIG. 4A illustrates an example structure of an antenna apparatus according to a first modification of the embodiment;

FIG. 4B illustrates an example structure of the antenna apparatus according to the first modification of the embodiment;

FIG. 5A illustrates an example structure of an antenna apparatus according to a second modification of the embodiment;

FIG. 5B illustrates an example structure of the antenna apparatus according to the second modification of the embodiment;

FIG. 5C illustrates an example structure of the antenna apparatus according to the second modification of the embodiment;

FIG. 5D illustrates an example structure of the antenna apparatus according to the second modification of the embodiment;

FIG. 6A illustrates an example structure of an antenna apparatus according to a third modification of the embodiment;

FIG. 6B illustrates an example structure of the antenna apparatus according to the third modification of the embodiment; and

FIG. 6C illustrates an example structure of the antenna apparatus according to the third modification of the embodiment.

### DESCRIPTION OF THE PREFERRED EMBODIMENTS

Hereinafter, an embodiment of an antenna apparatus according to the disclosure will be described.

### EMBODIMENT

### <Structure of Antenna Apparatus 100>

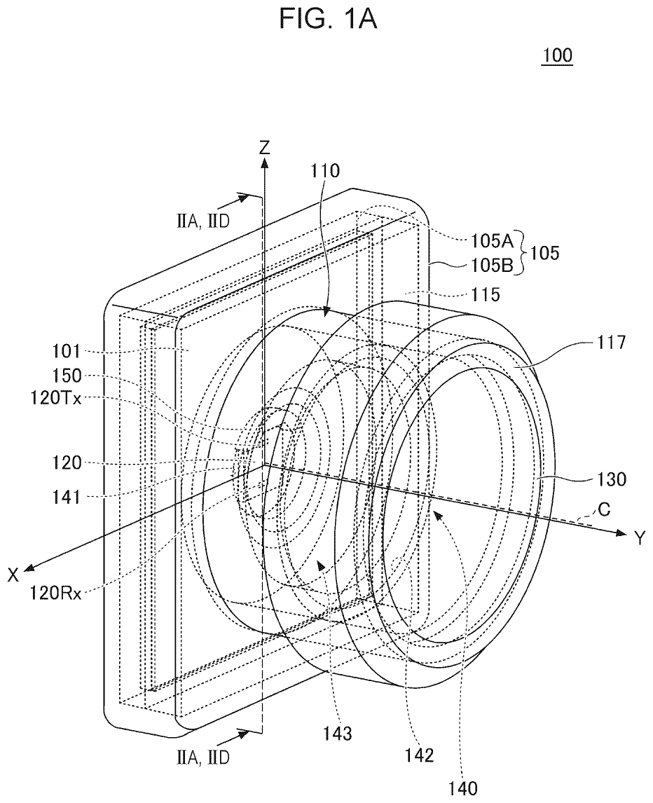

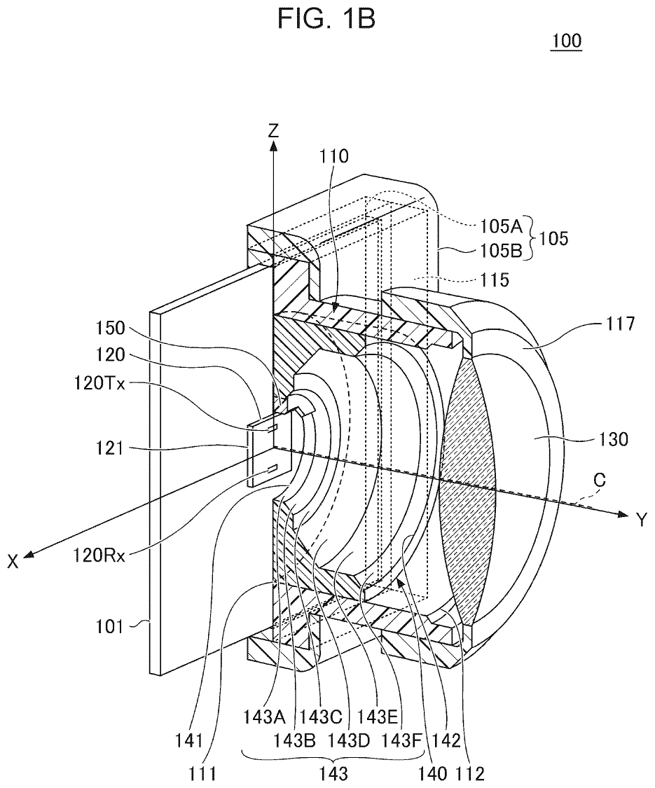

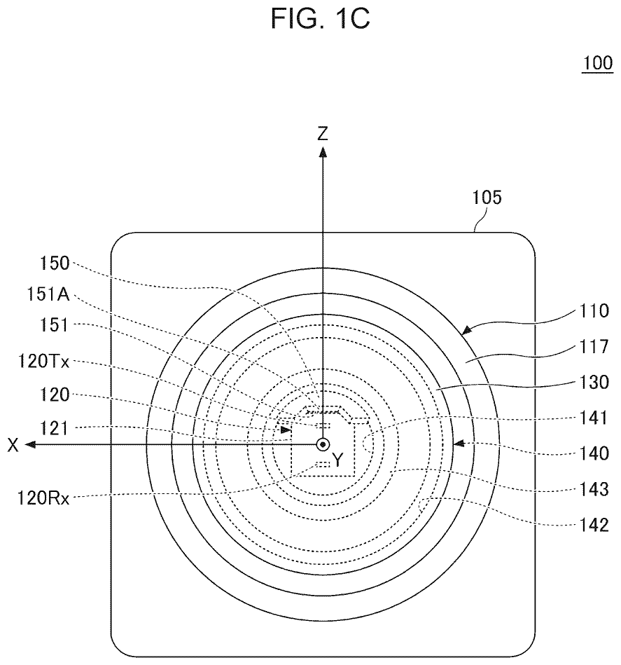

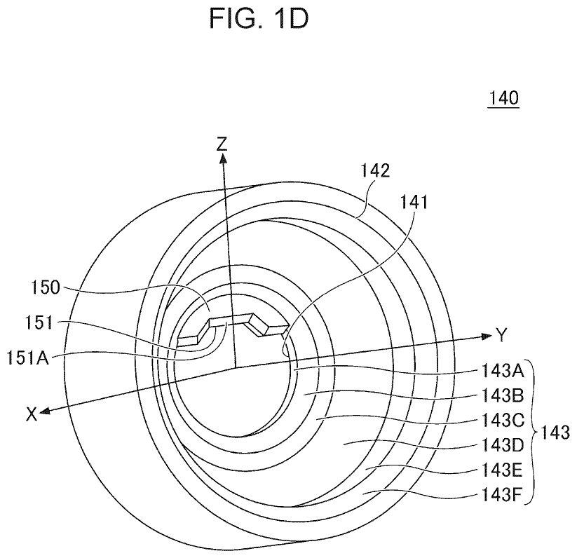

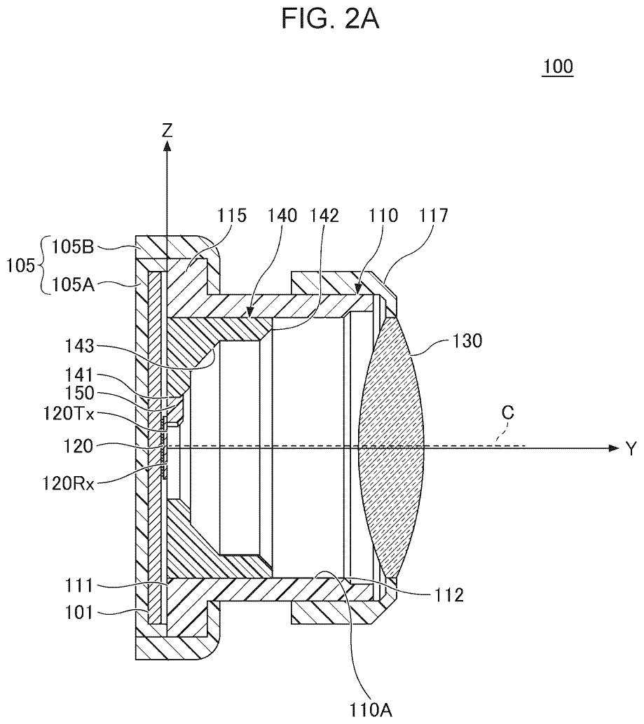

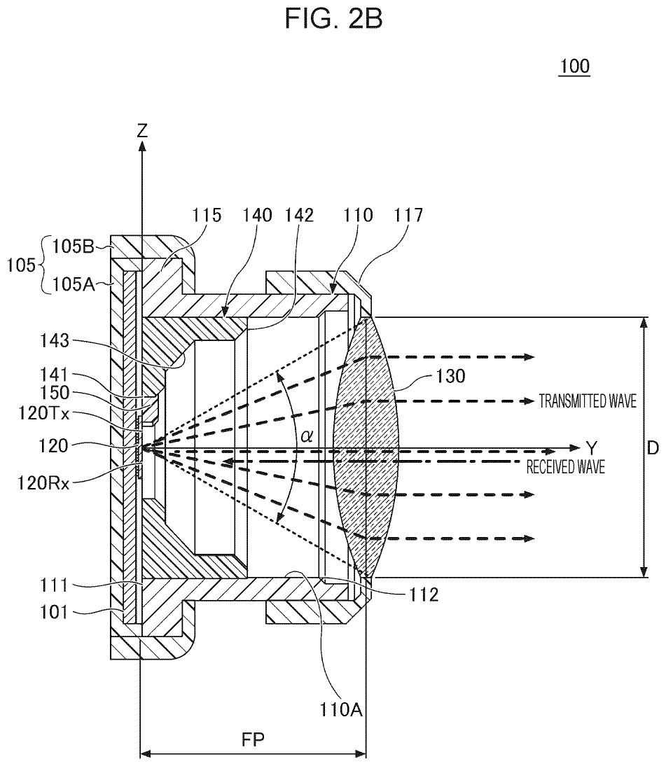

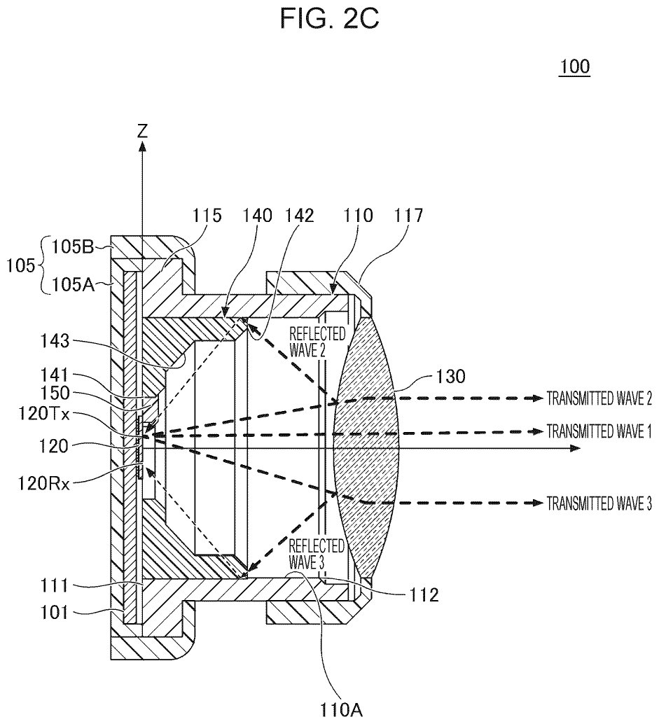

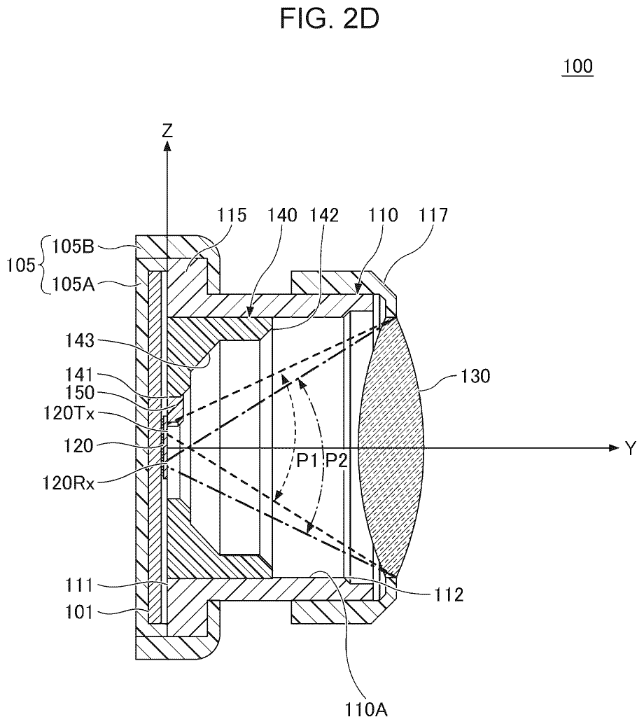

FIG. 1A, FIG. 1B, and FIG. 1C are schematic views of the antenna apparatus 100 according to the embodiment. FIG. 1D is a perspective view of a radio wave absorber 140 in the antenna apparatus 100 according to the embodiment. FIG. 1A is a perspective view, FIG. 1B is a diagram of a half section of a portion, and FIG. 1C is a front view. FIG. 2A is a cross-sectional view taken along line IIA-IIA, IID-IID in FIG. 1A, and illustrates a cross-section obtained by cutting a waveguide 110 in a YZ plane including an optical axis of a radio wave lens 130. Here, as long as not specifically mentioned, a structure of the antenna apparatus 100 will be described with reference to FIG. 1A, FIG. 1B, FIG. 1C, FIG. 1D, and FIG. 2A.

In the following description, an XYZ coordinate system is defined and described. For the sake of convenience, a −Z direction side denotes a lower side or bottom, and a +Z direction side denotes an upper side or top. However, this does not represent a universal vertical relationship. Viewing an XZ plane is referred to as plan view. In addition, viewing an aperture in XZ plane is referred to as aperture view.

The antenna apparatus 100 includes a board 101, the waveguide 110, a transmission/reception unit 120, the radio wave lens 130, the radio wave absorber 140, and a radio wave absorber 150. The radio wave absorber 150 is an example first radio wave absorber and the radio wave absorber 140 is an example second radio wave absorber. The antenna apparatus 100 may not include the radio wave absorber 140; however, here, a structure of the antenna apparatus 100 that includes the radio wave absorber 140 is described.

The antenna apparatus 100 is an apparatus that transmits and receives radio waves, and it narrows down a radiation pattern of transmitted waves using the radio wave lens 130 and focuses received radio waves using the lens to increase the receiver sensitivity. The antenna apparatus 100 attenuates transmitted waves using the radio wave absorber 150 to suppress an increase in EIRP and absorbs multiple reflected waves caused by multiple reflection inside using the radio wave absorber 140.

Such an antenna apparatus 100 may be used, for example, as a radar apparatus that measures a distance to a measurement target by receiving reflected waves of transmitted waves reflected by the measurement target and returned. Based on the time from the transmission of radio waves as transmitted waves to the reception of the radio waves as reflected waves, the distance to the measurement target can be measured.

Regarding EIRP of transmitted waves, in Japan, the upper limit is specified by the Radio Law. This is similar in other countries with international guidelines provided. Here, in a known antenna apparatus, when radio waves are transmitted and received, the antenna gains of the transmitted waves and received waves are equal. Accordingly, if the antenna gain is increased to improve the radio wave receiver sensitivity in the known antenna apparatus, in some cases, EIRP of the transmitted waves may exceed the upper limit specified by the Radio Law, whereas if the antenna gain is decreased to suppress EIRP, sufficient receiver sensitivity may not be achieved. The antenna apparatus 100 according to the embodiment solves such a problem by attenuating transmitted waves by using the radio wave absorber 150 to suppress an increase in EIRP and increase receiver sensitivity.

In addition, the detection accuracy of a radar apparatus for measuring a distance to a measurement target generally decreases due to the effects of multiple reflection as the measurement target becomes closer. This is because the closer the measurement target is, the shorter the round-trip time becomes, making it harder to distinguish between the received waves that have not undergone multiple reflection and the multiple-reflected waves. As detection accuracy decreases, the minimum detectable distance (minimum detection distance) increases. The antenna apparatus 100 according to the embodiment solves such a problem by using the radio wave absorber 140.

The multiple-reflected waves refer to radio waves that are reflected two or more times within a space surrounded by the board 101, the waveguide 110, the transmission/reception unit 120, the radio wave lens 130, and the radio wave absorber 140. For example, radio waves that are transmitted in the +Y direction from the transmission/reception unit 120 may be reflected by a surface of the radio wave lens 130 on the −Y direction side without passing through the radio wave lens 130 and cause multiple-reflected waves. For example, radio waves that pass through the radio wave lens 130 to the −Y direction side may be reflected by an inner wall surface 110A of the waveguide 110 or the like without directly reaching the transmission/reception unit 120 and cause multiple-reflected waves.

These radio waves transmitted and received by the antenna apparatus 100 are, for example, radio waves in the millimeter wave band. The millimeter waves are radio waves in the frequency band of 30 GHz to 300 GHz, and behave in a similar way to light. Note that the radio waves transmitted and received by the antenna apparatus 100 may be radio waves of frequencies that belong to bands other than the millimeter wave band.

### <Structure of Board 101>

The board 101 is a board on which the transmission/reception unit 120 is mounted, and for example, a wiring board complying with the Flame Retardant type 4 (FR-4) standard may be used. The board 101 is fixed to the −Y direction side of the waveguide 110.

### <Structure of Waveguide 110>

The waveguide 110 is, for example, a cylindrical, hollow circular waveguide. The waveguide 110 has an aperture 111, an aperture 112, the inner wall surface 110A, and an attachment section 115. The inside of the waveguide 110 serves as a waveguide through which radio waves propagate. The inner wall surface 110A is an example first inner wall surface, the aperture 111 is an example first aperture, and the aperture 112 is an example second aperture. The −Y direction side of the waveguide 110 is an example first aperture side, and the +Y direction side is an example second aperture side. The +Y direction is an example radiation direction of a transmitting antenna 120Tx of the transmission/reception unit 120.

In FIG. 1A, FIG. 1B, FIG. 1C, and FIG. 2A, the origin of the XYZ coordinate system is aligned with a center of the aperture 111, and a central axis C of the waveguide 110 is aligned with the Y-axis. The central axis C is also aligned with an optical axis of the radio wave lens 130. In the drawings, for ease of viewing, the central axis C and the Y-axis are shifted.

The inner wall surface 110A is an inner wall surface of the cylindrical, hollow circular waveguide 110. The waveguide 110 has, for example, a cylindrical shape in which an aperture diameter of the aperture 111 and an aperture diameter of the aperture 112 are equal. Accordingly, the inner wall surface 110A has a cylindrical shape with a constant diameter. Note that the aperture diameter of the aperture 111 may be larger than the aperture diameter of the aperture 112, and the aperture diameter of the aperture 112 may be larger than the aperture diameter of the aperture 111.

The aperture 111 is an aperture located at an end of the waveguide 110 on the −Y direction side. The aperture 111 is circular in aperture view. The aperture 112 is an aperture located at an end of the waveguide 110 on the +Y direction side. A section that functions as the waveguide 110 through which radio waves propagate is a section between the aperture 111 and the aperture 112. The aperture 112 is circular in aperture view. The aperture diameter of the aperture 112 is, for example, equal to the aperture diameter of the aperture 111. The radio wave lens 130 is attached to the aperture 112 by an attachment section 117.

The attachment section 115 is a section that extends outward in plan view at the end of the waveguide 110 on the −Y direction side, and for example, has a square outer edge in plan view. The attachment section 115 is provided to attach the board 101 to the waveguide 110. The outer edge of the attachment section 115 in plan view is held by a frame portion 105B of a cover 105 that covers a rear side (−Y direction side) of the board 101. The attachment section 115 is, for example, made of resin.

The attachment section 117 is a frame-shaped member for attaching the radio wave lens 130 to the waveguide 110 at the end of the waveguide 110 on the +Y direction side. The attachment section 117 is circular in plan view, and is fitted onto an outer circumferential surface of the waveguide 110 on the +Y direction side. The attachment section 117 holds the radio wave lens 130 at a position on the +Y direction side of the aperture 112. In a state in which the radio wave lens 130 is held by the attachment section 117, the optical axis of the radio wave lens 130 is aligned with the central axis C of the waveguide 110. The attachment section 117 is, for example, made of resin.

In a state in which the radio wave lens 130 is attached to the waveguide 110 by using the attachment section 117 as described above, a focal point of the radio wave lens 130 is positioned at a center of the aperture 111 in aperture view. In other words, the length of the waveguide 110 in the extending direction of the central axis C is set such that the focal point of the radio wave lens 130 is positioned on the aperture surface of the aperture 111.

### <Structure of Transmission Reception Unit 120>

The transmission/reception unit 120 is mounted on a surface of the board 101 on the +Y direction side. The transmission/reception unit 120 is an example integrated circuit chip. The transmission/reception unit 120 includes a substrate 121, the transmitting antenna 120Tx, and a receiving antenna 120Rx. The substrate 121 is smaller than the board 101 in plan view and is square, for example. The substrate 121 is disposed at a central portion of the aperture 111 in plan view. More specifically, the substrate 121 is disposed such that a center of the substrate 121 is positioned on the central axis C. The position of the surface of the substrate 121 on the +Y direction side in the Y direction is aligned with the position of the aperture 111 in the Y direction.

The transmitting antenna 120Tx and the receiving antenna 120Rx are spaced apart in the Z direction on the surface of the substrate 121 on the +Y direction side. The transmitting antenna 120Tx and the receiving antenna 120Rx are, for example, antennas that have the same shape and the same size. The transmitting antenna 120Tx transmits radio waves through the waveguide 110, and the receiving antenna 120Rx receives radio waves through the waveguide 110.

The transmitting antenna 120Tx and the receiving antenna 120Rx are disposed to be symmetrical in plan view with respect to the central axis C. Viewing the transmitting antenna 120Tx and the receiving antenna 120Rx in plan view is equivalent to viewing the transmitting antenna 120Tx and the receiving antenna 120Rx in aperture view (plan view) of the aperture 111.

The phrase that the transmitting antenna 120Tx and the receiving antenna 120Rx are symmetrical in plan view with respect to the central axis C means that a center of the transmitting antenna 120Tx in plan view and a center of the receiving antenna 120Rx in plan view are symmetrical in plan view with respect to the central axis C. The center of the transmitting antenna 120Tx in plan view and the center of the receiving antenna 120Rx in plan view are both located on the Z-axis. The central axis C is aligned with the optical axis of the radio wave lens 130, and the transmitting antenna 120Tx and the receiving antenna 120Rx are disposed to be shifted from the optical axis of the radio wave lens 130.

Since the center of the transmitting antenna 120Tx in plan view and the center of the receiving antenna 120Rx in plan view are both located on the Z-axis, and are disposed to be symmetrical in plan view with respect to the central axis C, in a cross-section obtained by cutting the waveguide 110 in the YZ plane including the optical axis of the radio wave lens 130, the transmitting antenna 120Tx and the receiving antenna 120Rx are disposed to be symmetrical in the +Z direction and the −Z direction with respect to the central axis C.

It is not possible to dispose the transmitting antenna 120Tx and the receiving antenna 120Rx on the central axis C (optical axis of the radio wave lens 130), and thus the transmitting antenna 120Tx and the receiving antenna 120Rx are disposed in this manner to have the same transmission and reception characteristics. The transmitting antenna 120Tx and the receiving antenna 120Rx may be implemented by using, for example, loop antennas, patch antennas, monopole antennas, dipole antennas, or other antennas.

Since the length of the waveguide 110 in the extending direction of the central axis C is set such that the focal point of the radio wave lens 130 is positioned on the aperture surface of the aperture 111, the positions of the transmitting antenna 120Tx and the receiving antenna 120Rx on the optical axis (central axis C of the waveguide 110) of the radio wave lens 130 in the extending direction are equal to the position of the focal point of the radio wave lens 130. In addition, a position of the substrate 121 on the surface on the +Y direction side in the Y direction is aligned with the position of the aperture 111 in the Y direction. Accordingly, the focal point of the radio wave lens 130 is aligned with a center (point on the central axis C) of the centers of the transmitting antenna 120Tx and the receiving antenna 120Rx on the surface of the substrate 121 on +Y direction side.

The strength of the radio waves (transmitted waves) radiated from the transmitting antenna 120Tx is strongest in a direction connecting the center of the transmitting antenna 120Tx and the center of the radio wave lens 130, and the strength of the radio waves (received waves) received by the receiving antenna 120Rx is strongest in the direction connecting the center of the receiving antenna 120Rx and the center of the radio wave lens 130. The center of the radio wave lens 130 is, on the optical axis (central axis C of the waveguide 110) of the radio wave lens 130, positioned at a center of the thickness of the radio wave lens 130 in the Y direction.

### <Structure of Radio Wave Lens 130>

The radio wave lens 130 is a lens that can bidirectionally focus radio waves transmitted and received by the transmitting antenna 120Tx and the receiving antenna 120Rx, and for example, the radio wave lens 130 is a circular biconvex lens in plan view. However, the radio wave lens 130 may be a plano-convex lens. Such biconvex lens and plano-convex lens are example convex lenses. Alternatively, the radio wave lens 130 may be a flat lens such as a flat lens having a Fresnel zone or a flat lens comprising metamaterial; however, here, an example of a biconvex lens will be described.

### <Structure of Radio Wave Absorber 140>

The radio wave absorber 140 is disposed in approximately half of a space on the −Y direction side in the inside of the waveguide 110. The radio wave absorber 140 is, for example, a component made by molding resin mixed with magnetic or dielectric powder or the like, and is a component that causes radio wave loss. The radio wave absorber 140 has an aperture 141, an aperture 142, and an inner wall surface 143. The aperture 141 is an example third aperture, the aperture 142 is an example fourth aperture, and the inner wall surface 143 is an example second inner wall surface.

The radio wave absorber 140 is disposed such that a central axis, which is parallel to the Y axis in a substantially truncated conical space surrounded by the inner wall surface 143 between the aperture 141 and the aperture 142, is aligned with the central axis C of the waveguide 110. The central axis C of the waveguide 110 is aligned with the optical axis of the radio wave lens 130, and thus the central axis of the radio wave absorber 140 is aligned with the central axis C of the waveguide 110 and the optical axis of the radio wave lens 130.

The aperture 141 is provided on the aperture 111 side, is smaller than the aperture 111 and the board 101 in aperture view of the aperture 111, and is an aperture that surrounds the transmitting antenna 120Tx and the receiving antenna 120Rx. The aperture 141 is smaller than the aperture 142 in aperture view, and is provided concentrically. A position of the aperture 141 in the Y direction is, for example, aligned with the aperture 111 of the waveguide 110 (see FIG. 2A), and centers of the aperture 141 and aperture 111 are aligned in aperture view.

The aperture 142 is provided on the rear side (aperture 112 side) with respect to the aperture 141 in the radiation direction, and is an aperture larger than the aperture 141. The aperture 142 is larger than the aperture 141 in aperture view and is provided concentrically. The position of the aperture 142 in the Y direction is, as illustrated in FIG. 2A, slightly closer to the +Y direction side than the middle of the apertures 111 and 112 of the waveguide 110. The length of the radio wave absorber 140 between the apertures 141 and 142 may be determined depending on the length of the waveguide 110 in the Y direction, the shape of the inner wall surface 143, and other factors.

The inner wall surface 143 is an inner wall surface that connects the aperture 141 and the aperture 142. The inner wall surface 143 has, from the −Y direction side to the +Y direction side, inner wall surfaces 143A, 143B, 143C, 143D, 143E, and 143F. An end of the inner wall surface 143A on the −Y direction side is the aperture 141, and the inner wall surface 143A is a cylindrical wall surface (wall surface corresponding to an inner circumferential surface of a cylinder) having a constant diameter, and the inner wall surface 143B is connected to an end on the +Y direction side.

The inner wall surface 143B is a wall surface (wall surface corresponding to an outer circumferential surface of a truncated cone) extending conically from the end of the inner wall surface 143A on the +Y direction side, and the inner wall surface 143C is connected to an end on the +Y direction side. The inner wall surface 143C has a plane parallel to the XZ plane and is circular in aperture view. The end of the inner wall surface 143B on the +Y direction side is connected to a center of the inner wall surface 143C as an aperture in aperture view of the radio wave absorber 140. The inner wall surface 143D is connected to an outer edge of the inner wall surface 143C.

The inner wall surface 143D is a side surface that extends conically from the end of the inner wall surface 143C on the +Y direction side, and the inner wall surface 143E is connected to an end on the +Y direction side. The inner wall surface 143E is a side surface that extends cylindrically from the end of the inner wall surface 143D on the +Y direction side, and has a constant diameter in the Y direction. The inner wall surface 143F is connected to an end of the inner wall surface 143E on the +Y direction side.

The inner wall surface 143F is a side surface that extends conically from the end of the inner wall surface 143E on the +Y direction side, and an end of the inner wall surface 143F on the +Y direction side is the aperture 142.

The radio wave absorber 140 has the space surrounded by the above-described inner wall surface 143 such that a primary radiation wave radiated from the transmitting antenna 120Tx in the +Y direction (radiation direction) does not come into contact with the inner wall surface 143. In other words, the inner wall surface 143 is located outside the radiation path of the primary radiation wave that is radiated from the transmitting antenna 120Tx. The primary radiation wave is a direct wave that is radiated from the transmitting antenna 120Tx and passes through the radio wave lens 130 without being reflected. The radiation path of the primary radiation wave radiated from the transmitting antenna 120Tx is the same as a first path P1 (see FIG. 2D) through which a first direct wave, which will be described below, passes, and the primary radiation wave radiated from the transmitting antenna 120Tx is the same as the first direct wave, which will be described below. Such a structure will be described in detail with reference to FIG. 2B.

### <Location of Inner Wall Surface 143>

FIG. 2B is a schematic view of an example location of the inner wall surface 143 of the radio wave absorber 140. In addition to FIG. 2A, to FIG. 2B, radio waves (transmitted waves) radiated from the transmitting antenna 120Tx, radio waves (received waves) received by the receiving antenna 120Rx, an angular aperture α of the radio wave lens 130, a diameter D of the radio wave lens 130, and a focal length FP of the radio wave lens 130 are added. The radio waves (transmitted waves) radiated from the transmitting antenna 120Tx are a primary radiation wave. Note that in FIG. 2B, some of the reference numerals are omitted for the sake of clarity.

An angular aperture α of the radio wave lens 130 is an angular aperture of the radio wave lens 130 as seen from the focal point of the radio wave lens 130, and is an angle corresponding to a primary radio wave radiation angle of a transmitting and receiving antenna that is a primary radiator when the transmitting and receiving antenna is placed at the focal point of the radio wave lens 130.

The angular aperture α of the radio wave lens 130 is expressed by the following Equation (1) when the diameter D of the radio wave lens 130 and the focal length FP of the radio wave lens 130 are used. The angular aperture α depends on the type and specific structure of the transmitting and receiving antenna (the transmitting antenna 120Tx and the receiving antenna 120Rx) of the transmission/reception unit 120.

$$α = 2 \cdot Arctan ( \frac{D}{2 FP} ) \qquad ( 1 )$$

The inner wall surface 143 of the radio wave absorber 140 is located outside the area represented by the angular aperture α. The area represented by the angular aperture α is included in the radiation path of the primary radiation wave that is radiated from the transmitting antenna 120Tx and thus the inner wall surface 143 is located outside the radiation path of the primary radiation wave radiated from the transmitting antenna 120Tx. The radio wave absorber 140 has the inner wall surface 143 of the shape located outside the area represented by the angular aperture α so as not to obstruct the radiation path of the primary radiation wave radiated from the transmitting antenna 120Tx. In addition, the radio wave absorber 140 is located outside the area represented by the angular aperture α so as not to obstruct the path of the radio waves (received waves) that pass through the radio wave lens 130 from the outside of the antenna apparatus 100 and are received by the receiving antenna 120Rx. Accordingly, the antenna apparatus 100 can detect a measurement target with high accuracy without a decrease in detection sensitivity caused by the attenuation of transmitted waves and received waves in the radiation path.

In FIG. 2B, radio waves (transmitted waves) as a primary radiation wave radiated from the transmitting antenna 120Tx are indicated by thick broken lines, and a radio wave (received wave) received by the receiving antenna 120Rx is indicated by thick alternating long and short dashed lines. The primary radiation wave is radiated within the range of the angular aperture α of the radio wave lens 130 and passes through the radio wave lens 130 without reaching the inner wall surface 143, as indicated by the thick broken lines. The received wave is focused when passing through the radio wave lens 130 and reaches the receiving antenna 120Rx without reaching the inner wall surface 143, as indicated by the thick alternating long and short dashed lines.

In FIG. 2B, when viewed from the focal point of the radio wave lens 130, the angular aperture of the radio wave lens 130 is smaller than the angular aperture of the aperture 112 of the waveguide 110. However, when viewed from the focal point of the radio wave lens 130, when the angular aperture of the aperture 112 of the waveguide 110 is smaller than the angular aperture of the radio wave lens 130, the inner wall surface 143 may have a shape that is located outside an area obtained by the following equation (2) represented by an angular aperture R of the aperture 112.

In FIG. 2B, the position of the focal point of the radio wave lens 130 is an intersection of the optical axis of the radio wave lens 130 and the surface of the substrate 121 of the transmission/reception unit 120. Accordingly, the angular aperture β of the aperture 112 viewed from the intersection of the optical axis of the radio wave lens 130 and the surface of the substrate 121 of the transmission/reception unit 120 satisfies the following Equation (2), wherein the diameter of the aperture 112 is Dd, and the distance between the intersection and the center of the aperture 112 is L.

$$β = 2 \cdot Arctan ( \frac{Dd}{2 L} ) \qquad ( 2 )$$

### <Absorption of Reflected Wave by Radio Wave Absorber 140>

FIG. 2C is an example of absorption of reflected waves by the radio wave absorber 140. In FIG. 2C, the received wave and the dimensions of the corners illustrated in FIG. 2B are omitted, and some of the reference numerals are omitted. FIG. 2C illustrates the transmitted wave 1 that is radiated from the transmitting antenna 120Tx and passes through a central portion of the radio wave lens 130, and the transmitted waves 2 and 3 that are radiated from the transmitting antenna 120Tx and passes through outside the central portion of the radio wave lens 130.

The transmitted wave 1 passes through the surface of the radio wave lens 130 on the −Y direction side with almost no reflection. The transmitted wave 2 is partially reflected when passing through the outside of the central portion of the radio wave lens 130 and generates a reflected wave 2. The reflected wave 2 is reflected toward the inner wall surface 110A of the waveguide 110, but reaches the inner wall surface 143 of the radio wave absorber 140, and thus the reflected wave 2 is absorbed by the radio wave absorber 140. Note that if the radio wave absorber 140 is not provided, the reflected wave 2 is reflected by the surface of the radio wave lens 130 on the −Y direction side and reflected by the inner wall surface 110A of the waveguide 110 as indicated by the thin broken line, and may reach the transmission/reception unit 120 as a multiple-reflected wave.

In addition, similarly to the transmitted wave 2, the transmitted wave 3 is partially reflected when passing through the outside of the central portion of the radio wave lens 130 and generates a reflected wave 3. The reflected wave 3 is reflected toward the inner wall surface 110A of the waveguide 110, but reaches the inner wall surface 143 of the radio wave absorber 140, and thus the reflected wave 3 is absorbed by the radio wave absorber 140. Note that if the radio wave absorber 140 is not provided, the reflected wave 3 may be reflected by the surface of the radio wave lens 130 on the −Y direction side and reflected by the inner wall surface 110A of the waveguide 110 as indicated by the thin broken line, and may reach the transmission/reception unit 120 as a multiple-reflected wave.

In addition to such transmitted waves 2 and 3, in some cases, the transmitted wave 1, which reaches closer to the central portion of the radio wave lens 130 than the transmitted waves 2 and 3, may be reflected by the surface of the radio wave lens 130 on the −Y direction side, or transmitted waves that reach outside the radio wave lens 130 further than the transmitted waves 2 and 3 may be reflected by the surface of the radio wave lens 130 on the −Y direction side. If the radio wave absorber 140 is not provided, these reflected waves may be further reflected and cause multiple-reflected waves, and in such a case, these waves may reach the transmission/reception unit 120.

In addition, if the radio wave absorber 140 is not provided, these reflected waves may be reflected by the surface of the board 101 and cause multiple-reflected waves.

However, since the radio wave absorber 140 is disposed in reality as illustrated in FIG. 2C, most of the multiple-reflected waves can be absorbed. As described above, multiple-reflected waves can be absorbed by the radio wave absorber 140 and the receiving antenna 120Rx can be prevented from receiving multiple-reflected waves.

When multiple-reflected waves are received by the receiving antenna 120Rx, it is difficult to distinguish between received waves that pass through the radio wave lens 130 and directly reach the receiving antenna 120Rx and the received multiple-reflected waves. In such a case, the detection accuracy of received waves that pass through the radio wave lens 130 and directly reach the receiving antenna 120Rx decreases. As a measurement target is closer, the detection accuracy decreases due to the effects of multiple reflection, and a minimum detection distance becomes longer.

The antenna apparatus 100 according to the embodiment includes the above-described radio wave absorber 140, preventing the receiving antenna 120Rx from receiving multiple-reflected waves. The antenna apparatus 100 according to the embodiment achieves an increased received wave detection accuracy of the receiving antenna 120Rx, and can realize shortened minimum detection distance and increased detection performance.

### <Structure of Radio Wave Absorber 150>

The radio wave absorber 150 is described with reference to FIG. 2D, in addition to FIGS. 1A to 1D and FIGS. 2A to 2C. FIG. 2D is a schematic view of an example of the first path P1 and the second path P2 in the cross-sectional view taken along line IIA-IIA, IID-IID in FIG. 1A.

The radio wave absorber 150 is provided to attenuate radio waves that are radiated by the transmitting antenna 120Tx. The radio wave absorber 150 attenuates transmitted waves to regulate the power of the transmitted waves to values less than or equal to the upper limit specified by the Radio Law but does not attenuate received waves, thereby enabling the receiving antenna 120Rx to achieve high receiver sensitivity. The radio wave absorber 150 is, similarly to the radio wave absorber 140, for example, a component made by molding resin mixed with magnetic or dielectric powder or the like, and is a component that causes radio wave loss.

The radio wave absorber 150 is located within the aperture 141 of the radio wave absorber 140 in aperture view of the aperture 111, and is disposed on an upper (+Z) side of the inner wall surfaces 143A and 143B of the inner wall surface 143 of the radio wave absorber 140. Here, the structure of the radio wave absorber 150 is described with reference to the radial direction of the aperture 141 of the radio wave absorber 140.

An outer surface of the radio wave absorber 150 in the radial direction is in contact with the inner wall surfaces 143A and 143B. Accordingly, the boundary between the radio wave absorber 150 and the radio wave absorber 140 is curved.

The radio wave absorber 150 is provided, in the Y direction, from the surface of the radio wave absorber 140 on the −Y direction side to a location between the end on the −Y direction side and the end on the +Y direction side of the inner wall surface 143B. The location of the surface of the radio wave absorber 140 on the −Y direction side in the Y direction is equal to the location of the aperture 141 in the Y direction. Accordingly, the radio wave absorber 150, in aperture view of the aperture 111, overlaps a portion of the board 101, and overlaps a portion of the transmission/reception unit 120 mounted on the surface of the board 101 on the +Y direction side.

As illustrated in FIG. 1C and FIG. 1D, the radio wave absorber 150 has a C-shape in aperture view of the aperture 111, and is provided on the upper side of the inner wall surfaces 143A and 143B of the inner wall surface 143 in a state in which the C-shape is rotated 90 degrees clockwise. In other words, as illustrated in FIG. 1C, in aperture view of the aperture 111, the radio wave absorber 150 is disposed on the upper side to the transmitting antenna 120Tx, on the oblique upper side to the transmitting antenna 120Tx on the +X direction side, and on the oblique upper side to the transmitting antenna 120Tx on the −X direction side.

As illustrated in FIG. 1C and FIG. 1D, the radio wave absorber 150 has a recessed portion 151 that is recessed in the +Z direction over the transmitting antenna 120Tx in aperture view of the aperture 111. A surface of the recessed portion 151 facing the central axis C has, for example, three planes. In addition, chamfered portions 151A are formed between portions of the surface on the +Y direction side of the recessed portion 151 facing the central axis C and the surface of the radio wave absorber 150 on the +Y direction side. The chamfered portions 151A are diagonally chamfered corners between the surface of the recessed portion 151 facing the central axis C and the surface of the radio wave absorber 150 on the +Y direction side.

Note that, although the recessed portion 151 has the three planes as illustrated in FIGS. 1C and 1D, the structure is not limited to this example and the recessed portion 151 may be curved in a shape of an arc, for example. Alternatively, the radio wave absorber 150 may omit the chamfered portions 151A.

Although the radio wave absorber 150 and the radio wave absorber 140 are integrated into one unit as an example, the radio wave absorber 150 may be fabricated separately from the radio wave absorber 140 and attached to the radio wave absorber 140. When the radio wave absorber 150 is integrally formed with the radio wave absorber 140, for example, the component may be fabricated by integral molding or machining. In the cross-sectional view in FIG. 2D, the radio wave absorber 150 and the radio wave absorber 140 are illustrated with different types of hatching to distinguish the radio wave absorber 150 from the radio wave absorber 140.

As illustrated in FIG. 2D, the radio wave absorber 150 is disposed on the aperture 111 side in a space surrounded by the inner wall surface 110A of the waveguide 110. This is because the transmitting antenna 120Tx is disposed on the aperture 111 side. At least part of the radio wave absorber 150 is located inside the first path P1 of a first direct wave that is radiated from the transmitting antenna 120Tx and directly reaches the radio wave lens 130. This structure is provided to attenuate the first direct wave. The radio wave absorber 150 is located outside the second path P2 of a second direct wave that passes through the radio wave lens 130 and directly reaches the receiving antenna 120Rx. This structure is provided to enable the receiving antenna 120Rx to achieve high and good receiver sensitivity without attenuating the second direct wave.

The first direct wave is a direct wave that is radiated from the transmitting antenna 120Tx, directly reaches the radio wave lens 130, and passes through the radio wave lens 130. The first path P1 is a three-dimensional path through which the first direct wave can pass between the transmitting antenna 120Tx and the radio wave lens 130, and is a three-dimensional spatial area through which the first direct wave can pass. The phrase at least part of the radio wave absorber 150 is located inside the first path P1 means that at least part of the radio wave absorber 150 is located within the three-dimensional spatial area through which the first direct wave can pass through. The first path P1 is the same as a radiation path of a primary radiation wave that is radiated from the transmitting antenna 120Tx. The primary radiation wave radiated from the transmitting antenna 120Tx is the same as the first direct wave.

The three-dimensional spatial area through which the first direct wave can pass through is a spatial area that connects the outer edge of the radio wave lens 130 and the outer edge of the transmitting antenna 120Tx. When the aperture 112 of the waveguide 110 is located inside with respect to the outer edge of the radio wave lens 130, the three-dimensional spatial area through which the first direct wave can pass through is a spatial area that connects the aperture 112 of the waveguide 110 and the outer edge of the transmitting antenna 120Tx.

The second direct wave is a received wave that comes from outside (+Y direction side) the radio wave lens 130, passes through the radio wave lens 130, and directly reaches the receiving antenna 120Rx. The second path P2 is a three-dimensional path through which the second direct wave can pass between the receiving antenna 120Rx and the radio wave lens 130, and is a three-dimensional spatial area through which the second direct wave can pass. The phrase the radio wave absorber 150 is located outside the second path P2 means that the entire radio wave absorber 150 is located outside the three-dimensional spatial area through which the second direct wave can pass through, and the entire radio wave absorber 150 is not located inside the three-dimensional spatial area through which the second direct wave can pass through.

The three-dimensional spatial area through which the second direct wave can pass through is a spatial area that connects the outer edge of the radio wave lens 130 and the outer edge of the receiving antenna 120Rx. When the aperture 112 of the waveguide 110 is located inside with respect to the outer edge of the radio wave lens 130, the three-dimensional spatial area through which the second direct wave can pass through is a spatial area that connects the aperture 112 of the waveguide 110 and the outer edge of the receiving antenna 120Rx.

The radio wave absorber 150 is disposed on the transmitting antenna 120Tx side with respect to the central axis C of the waveguide 110 in aperture view of the aperture 111. The radio wave absorber 150 attenuates radio waves that are radiated by the transmitting antenna 120Tx, and is not located inside the second path P2 of radio waves received by the receiving antenna 120Rx, and thus the radio wave absorber 150 is disposed on the transmitting antenna 120Tx side with respect to the central axis C of the waveguide 110 in aperture view of the aperture 111. Note that the central axis C is aligned with the optical axis of the radio wave lens 130.

In the above description, regarding the radio wave absorber 140, it has been described that the inner wall surface 143 has the shape the inner wall surface 143 is located outside the area represented by the angular aperture α represented by the equation (1) or the shape the inner wall surface 143 is located outside the area represented by the angular aperture β of the aperture 112 obtained by the equation (2). However, in the radio wave absorber 140, the inner wall surface 143 may be located outside the first path P1 and the second path P2.

### <Simulation Results>

To verify the effects of the radio wave absorber 150, simulations were conducted on a comparative antenna apparatus that does not include the radio wave absorber 150 and the antenna apparatus 100 that includes the radio wave absorber 150 according to the embodiment, and radiation characteristics of the transmitting antenna 120Tx and the receiving antenna 120Rx were calculated. The comparative antenna apparatus had a structure in which the radio wave absorber 150 was removed from the antenna apparatus 100.

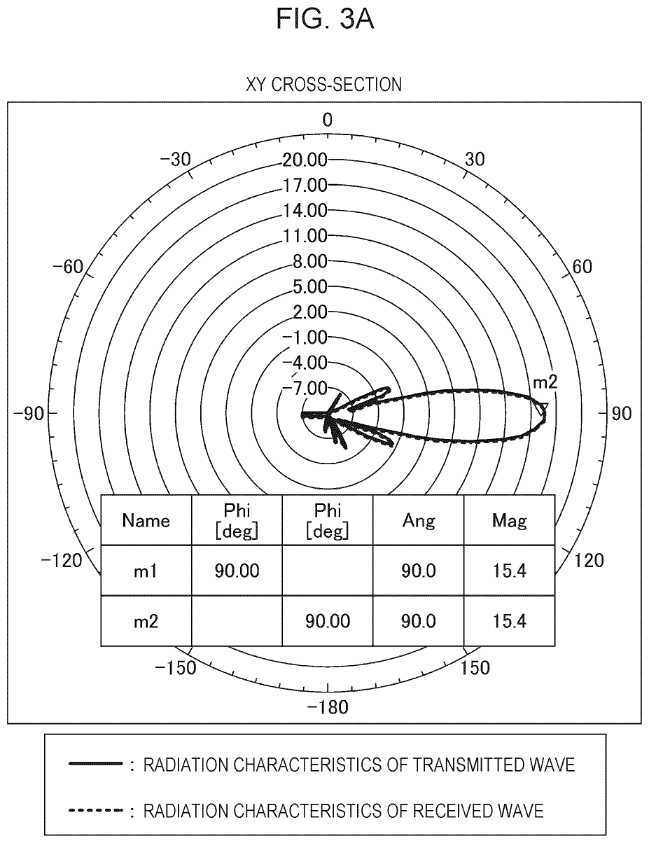

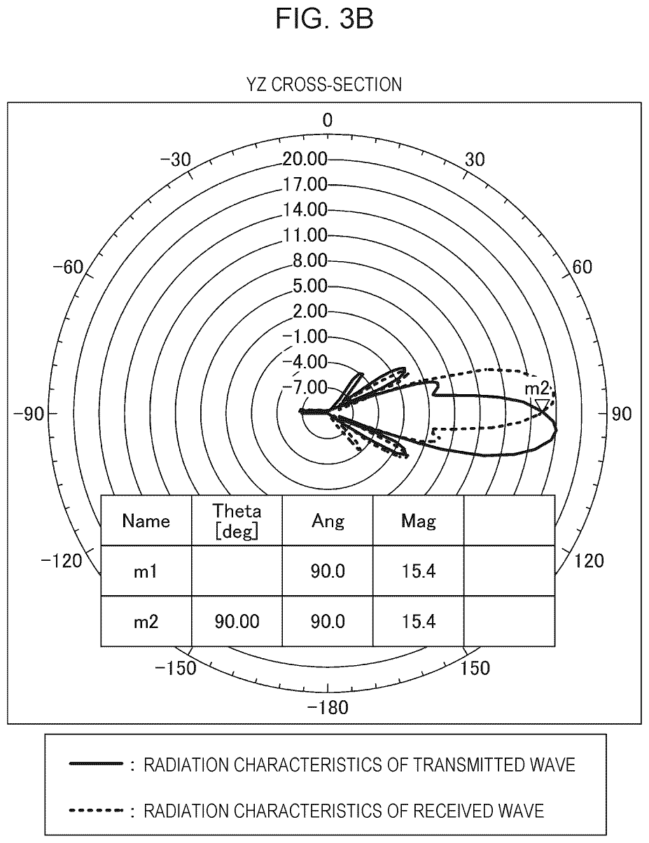

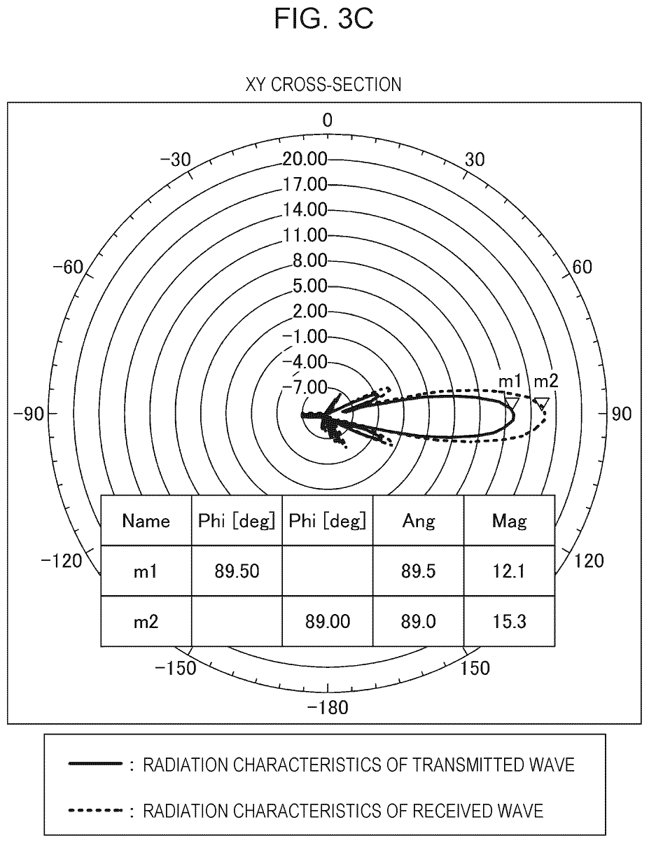

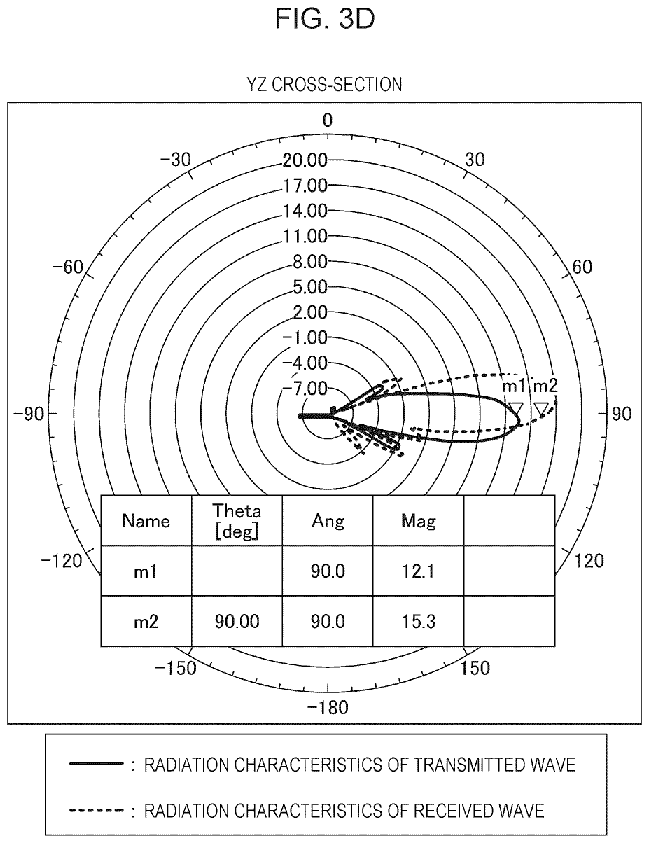

FIG. 3A and FIG. 3B illustrate examples of radiation characteristics of the comparative antenna apparatus. FIG. 3C and FIG. 3D illustrate examples of radiation characteristics of the antenna apparatus 100 according to the embodiment. FIG. 3A and FIG. 3C illustrate radiation characteristics in the XY cross-section passing through the central axis C, and FIG. 3B and FIG. 3D illustrate radiation characteristics in the YZ cross-section passing through the central axis C. In FIG. 3A and FIG. 3D, the central axis C is located on the straight line connecting −90 degrees and 90 degrees.

The radiation characteristics of the comparative antenna apparatuses illustrated in FIG. 3A and FIG. 3B were calculated by setting the receiver sensitivity of the receiving antenna 120Rx to a desired high level and setting the configurations of the transmitting antenna 120Tx and receiving antenna 120Rx to be the same. The radiation characteristics of the transmitted waves are indicated by solid lines, and the radiation characteristics of the received waves are indicated by broken lines.

In FIG. 3A, the radiation characteristics of the transmitted wave and the received wave are equal, and the radiation characteristics of the transmitted wave (solid line) and the radiation characteristics of the received wave (broken line) completely overlap, and thus only the radiation characteristics of the transmitted wave indicated by the solid line is illustrated. In FIG. 3B, it can be confirmed that the radiation characteristics of the transmitted wave on the +Z direction side and the radiation characteristics of the received wave on the −Z direction side do not overlap. This is because the transmitting antenna 120Tx is located above the central axis C, and the receiving antenna 120Rx is located below the central axis C.

The gains (antenna gains) of the transmitted wave and the received wave in the comparative antenna apparatus were both 15.4 dB. The receiving antenna 120Rx was set to have a desired high level of receiver sensitivity, and thus the power of the transmitted wave (EIRP) exceeded the upper limit of power specified by the Radio Law.

In FIG. 3C, it can be confirmed that the radiation characteristics of the transmitted wave and the received wave were different, and the gain of the transmitted wave was smaller than the gain of the received wave. In FIG. 3D, it can also be confirmed that the gain of the transmitted wave was smaller than the gain of the received wave.

The gain of the transmitted wave in the antenna apparatus 100 according to the embodiment was 12.1 dB, and the gain of the received wave was 15.3 dB. Although the receiving antenna 120Rx was set to have the desired high level of receiver sensitivity, the power of the transmitted wave was kept below the upper limit of power specified by the Radio Law. Therefore, it was confirmed that by providing the radio wave absorber 150, it was possible to achieve high and good receiver sensitivity while the power of the transmitted wave was kept below the upper limit of power specified by the Radio Law.

### <Effects>

The antenna apparatus 100 includes the board 101, the transmission/reception unit 120 that includes the transmitting antenna 120Tx and the receiving antenna 120Rx and is mounted on the board 101, the waveguide 110 that has the aperture 111 (first aperture) that is provided on the board 101 side and surrounds the transmitting antenna 120Tx and the receiving antenna 120Rx in aperture view, the aperture 112 (second aperture) that is provided on the rear side with respect to the aperture 111 (first aperture) in the radiation direction of the transmitting antenna 120Tx, and the inner wall surface 110A (first inner wall surface) that connects the aperture 111 (first aperture) and the aperture 112 (second aperture), the radio wave lens 130 fixed to the aperture 112 (second aperture), and the radio wave absorber 150 (first radio wave absorber) that is disposed on the aperture 111 (first aperture) side in the space surrounded by the inner wall surface 110A (first inner wall surface). At least part of the radio wave absorber 150 (first radio wave absorber) is located inside the first path of the first direct wave that is radiated from the transmitting antenna 120Tx, directly reaches the radio wave lens 130, and passes through the radio wave lens 130, and the radio wave absorber 150 (first radio wave absorber) is located outside the second path of the second direct wave that passes through the radio wave lens 130 and directly reaches the receiving antenna 120Rx. With this structure, high receiver sensitivity can be achieved without attenuating the received wave while attenuating the transmitted wave.

Accordingly, the antenna apparatus 100 capable of suppressing an increase in EIRP and achieving good receiver sensitivity can be provided.

The transmitting antenna 120Tx and the receiving antenna 120Rx are disposed across the central axis C (the optical axis of the radio wave lens 130). This structure enables the first path P1 of the first direct wave and the second path P2 of the second direct wave to be shifted above and below the central axis C, and enables the radio wave absorber 150 to be disposed inside the first path P1 and outside the second path P2. Accordingly, with the positional difference between the first path P1 and the second path P2, the antenna apparatus 100 capable of suppressing an increase in EIRP and achieving good receiver sensitivity can be provided.

The radio wave absorber 150 (first radio wave absorber) is disposed on the transmitting antenna 120Tx side with respect to the central axis C (optical axis of the radio wave lens 130) in aperture view of the aperture 111 (first aperture). Accordingly, by providing the radio wave absorber 150 on the first path P1 side, the antenna apparatus 100 capable of attenuating transmitted waves, suppressing an increase in EIRP, and achieving good receiver sensitivity can be provided.

The antenna apparatus 100 further includes the cylindrical radio wave absorber 140 (second radio wave absorber) that is provided inside the inner wall surface 110A (first inner wall surface). The radio wave absorber 140 (second radio wave absorber) includes the aperture 141 (third aperture) that is provided on the aperture 111 (first aperture) side, is smaller than the aperture 111 (first aperture) and the board 101 in aperture view of the aperture 111 (first aperture), and surrounds the transmitting antenna 120Tx and the receiving antenna 120Rx, the aperture 142 (fourth aperture) that is provided on the rear side with respect to the aperture 141 (third aperture) in the radiation direction and is larger than the aperture 141 (third aperture) and the inner wall surface 143 (second inner wall surface) that connects the aperture 141 (third aperture) and the aperture 142 (fourth aperture). Accordingly, the antenna apparatus 100 capable of reducing effects of multiple reflection and increasing the detection performance, and also capable of suppressing an increase in EIRP and achieving good receiver sensitivity can be provided.

The radio wave absorber 150 (first radio wave absorber) is integrally formed with the radio wave absorber 140 (second radio wave absorber). Accordingly, the radio wave absorbers 140 and 150 can be fabricated simultaneously, and the number of components can be reduced. In addition, positioning of the radio wave absorbers 140 and 150 with respect to the transmitting antenna 120Tx and the receiving antenna 120Rx can be performed simultaneously.

### <First Modification>

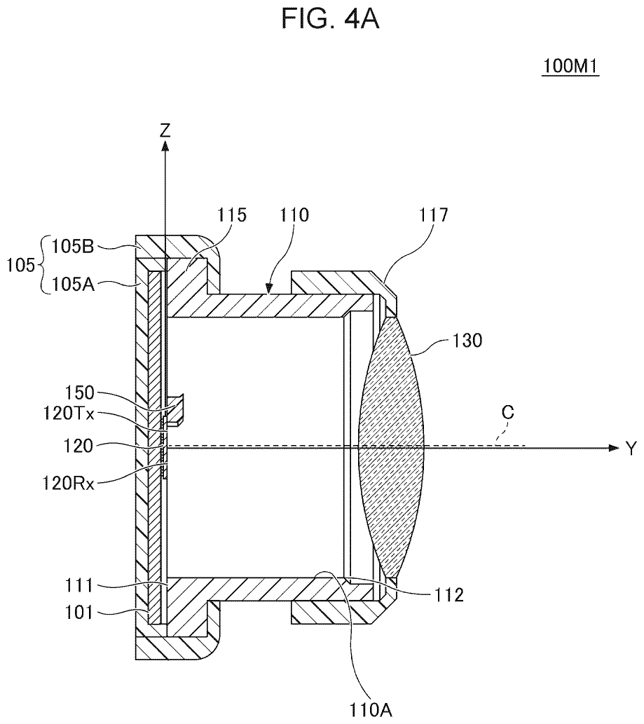

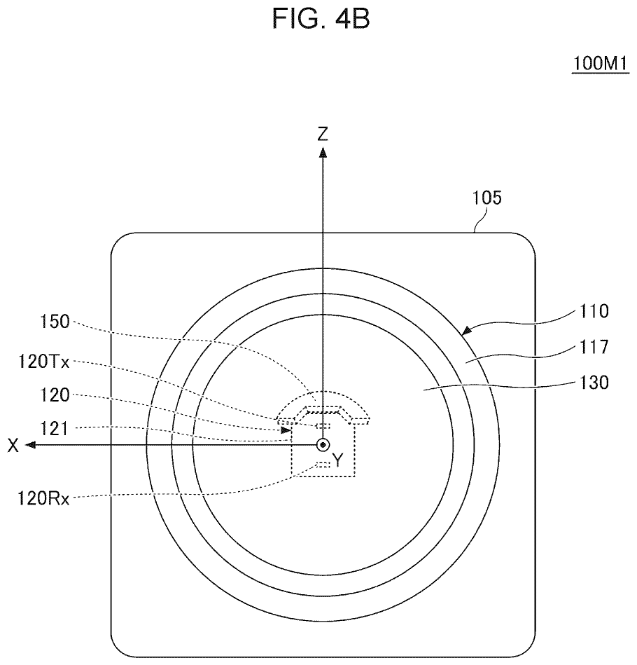

FIG. 4A and FIG. 4B are diagrams of an example structure of an antenna apparatus 100M1 according to a first modification of the embodiment. Here, differences between the antenna apparatus 100 and the antenna apparatus 100M1 will be described. Among the components of the antenna apparatus 100M1, the same reference numerals are given to components similar to those in the antenna apparatus 100 and their descriptions will be omitted.

The antenna apparatus 100M1 has a structure in which the radio wave absorber 140 is removed from the antenna apparatus 100, and the radio wave absorber 150 is attached to the surface of the board 101 on the +Y direction side. The location and size of the radio wave absorber 150 in the antenna apparatus 100M1 are the same as the location and size of the radio wave absorber 150 in the antenna apparatus 100. For example, in a case in which effects of multiple reflection are small, the radio wave absorber 140 may be omitted as in the antenna apparatus 100M1.

In addition, in the antenna apparatus 100M1, the radio wave absorber 150 is attached to the board 101, and thus the radio wave absorber 150 that has a higher positioning accuracy with respect to the transmitting antenna 120Tx can be provided. For example, when the antenna apparatus 100 is mounted on a vehicle or the like, even if misalignments occur between the board 101 and the cover 105, the waveguide 110, and other components, the position of the radio wave absorber 150 with respect to the transmitting antenna 120Tx is not changed, and thus the transmitted wave can be attenuated highly accurately.

The antenna apparatus 100M1 can provide high receiver sensitivity without attenuating received waves while attenuating transmitted waves using the radio wave absorber 150, and thus the antenna apparatus 100M1 with good radio wave receiver sensitivity can be provided. In addition, the positioning accuracy of the radio wave absorber 150 with respect to the transmitting antenna 120Tx is high, and transmitted waves can be attenuated highly accurately.

### <Second Modification>

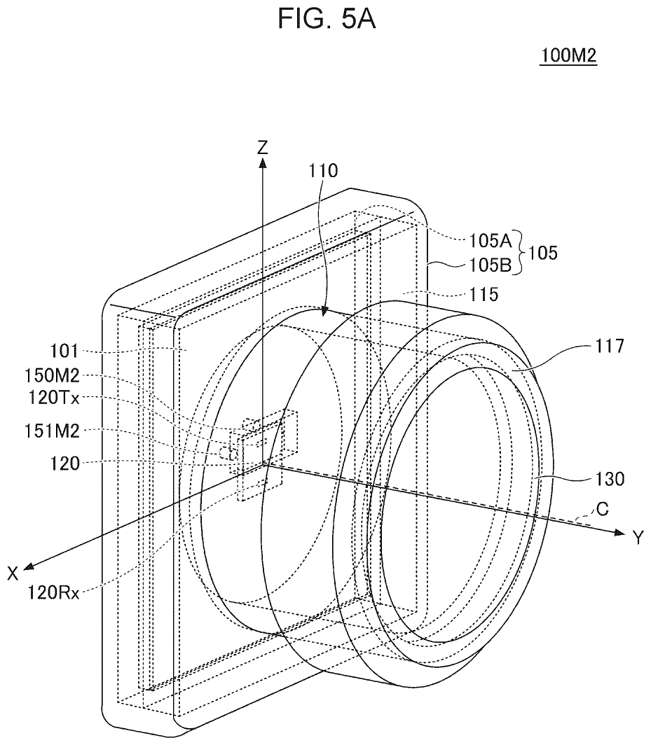

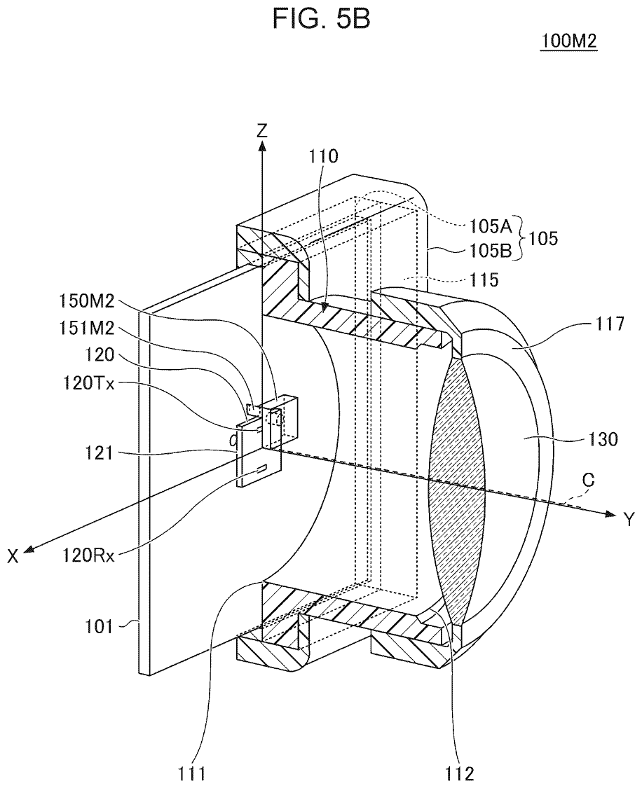

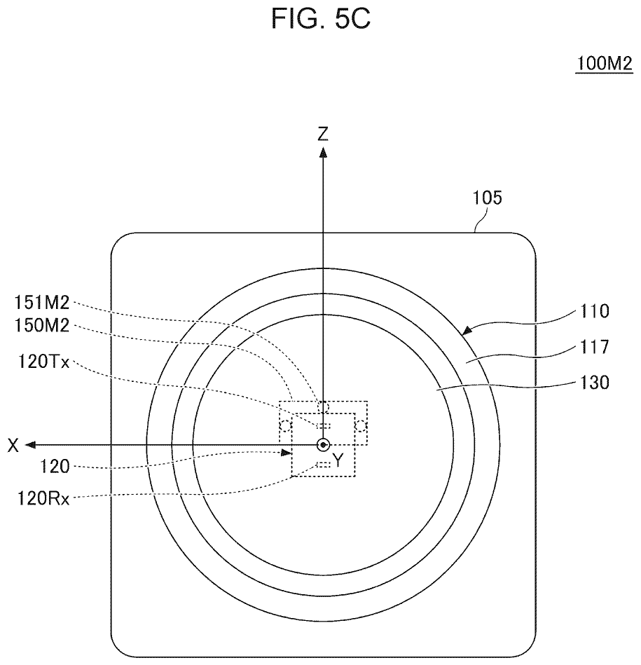

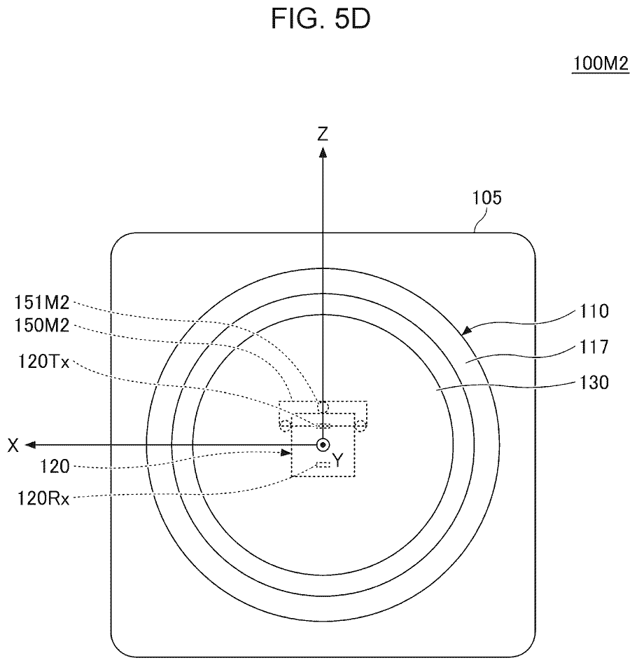

FIG. 5A to FIG. 5D are diagrams of an example structure of an antenna apparatus 100M2 according to a second modification of the embodiment. Here, differences between the antenna apparatuses 100 and 100M1 and the antenna apparatus 100M2 will be described. Among the components of the antenna apparatus 100M2, the same reference numerals are given to components similar to those in the antenna apparatuses 100 and 100M1 and their descriptions will be omitted.

First, the description will be made with reference to FIGS. 5A to 5C. The antenna apparatus 100M2 has a structure in which the radio wave absorber 140 is removed from the antenna apparatus 100, and a radio wave absorber 150M2 is attached to the surface of the board 101 on the +Y direction side. The radio wave absorber 150M2 is different from the radio wave absorber 150 in the antenna apparatuses 100 and 100M1 in that, in aperture view of the aperture 111, the radio wave absorber 150M2 covers the transmitting antenna 120Tx, and the radio wave absorber 150M2 is attached to the surface of the transmission/reception unit 120 with three legs 151M2 that protrude toward the −Y direction side. For example, in a case in which effects of multiple reflection are small, the radio wave absorber 140 may be omitted as in the antenna apparatus 100M2.

For example, when a transmitted wave is attenuated from a state in which the gains of the transmitting antenna 120Tx and the receiving antenna 120Rx are the same to reduce the power to less than or equal to the upper limit specified by the Radio Law, in aperture view of the aperture 111, if it is better to cover the transmitting antenna 120Tx, the radio wave absorber 150M2 that covers the transmitting antenna 120Tx in aperture view of the aperture 111 may be used.

In addition, in the antenna apparatus 100M2, the radio wave absorber 150M2 is attached to the board 101 similarly to the antenna apparatus 100M1, and thus the radio wave absorber 150M2 that has a higher positioning accuracy with respect to the transmitting antenna 120Tx can be provided. For example, when the antenna apparatus 100M2 is mounted on a vehicle or the like, even if misalignments occur between the board 101 and the cover 105, the waveguide 110, and other components, the position of the radio wave absorber 150M2 with respect to the transmitting antenna 120Tx is not changed, and thus the transmitted wave can be attenuated highly accurately.

The antenna apparatus 100M2 can provide high receiver sensitivity without attenuating received waves while attenuating transmitted waves using the radio wave absorber 150M2, and thus the antenna apparatus 100M2 with good radio wave receiver sensitivity can be provided. In addition, the positioning accuracy of the radio wave absorber 150M2 with respect to the transmitting antenna 120Tx is high, and transmitted waves can be attenuated highly accurately.

Note that the radio wave absorber 150M2 may cover part of the transmitting antenna 120Tx in aperture view of the aperture 111. In other words, in aperture view of the aperture 111, the radio wave absorber 150M2 may cover at least part of the transmitting antenna 120Tx. FIG. 5D illustrates the radio wave absorber 150M2 that covers the upper half of the transmitting antenna 120Tx in aperture view of the aperture 111.

The radio wave absorber 150M2 that covers at least part of the transmitting antenna 120Tx in aperture view of the aperture 111 can attenuate transmitted waves. In addition, by adjusting the length of the radio wave absorber 150M2 in the longitudinal direction to adjust the portion of the radio wave absorber 150M2 that covers the transmitting antenna 120Tx, the degree of attenuation of transmitted waves can be set.

### <Third Modification>

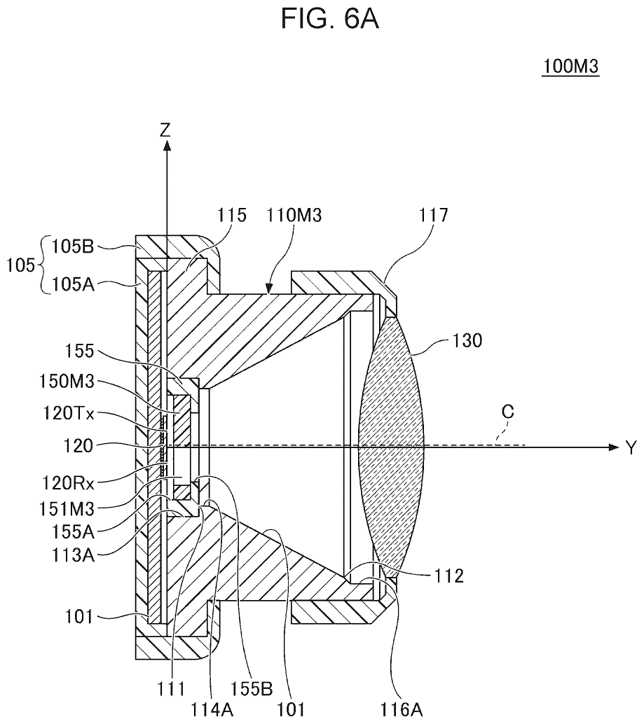

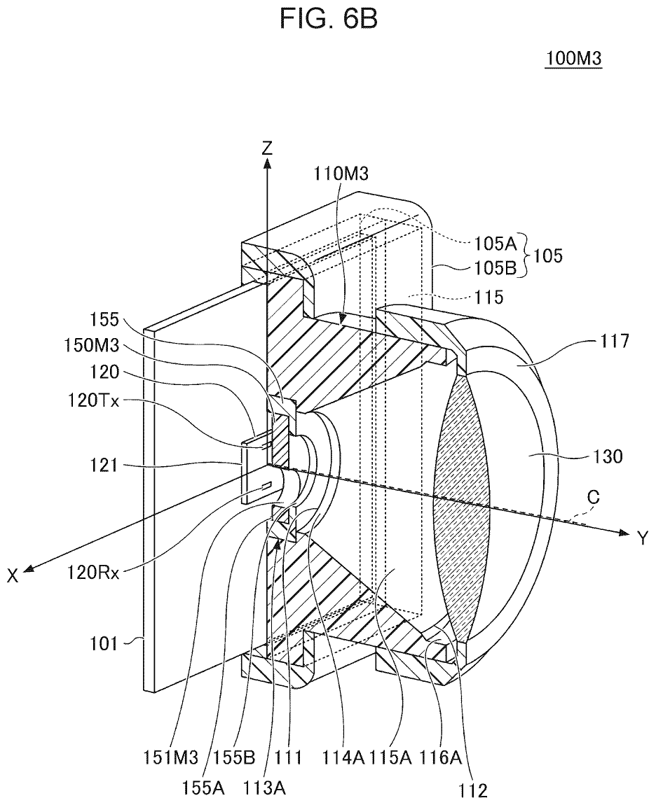

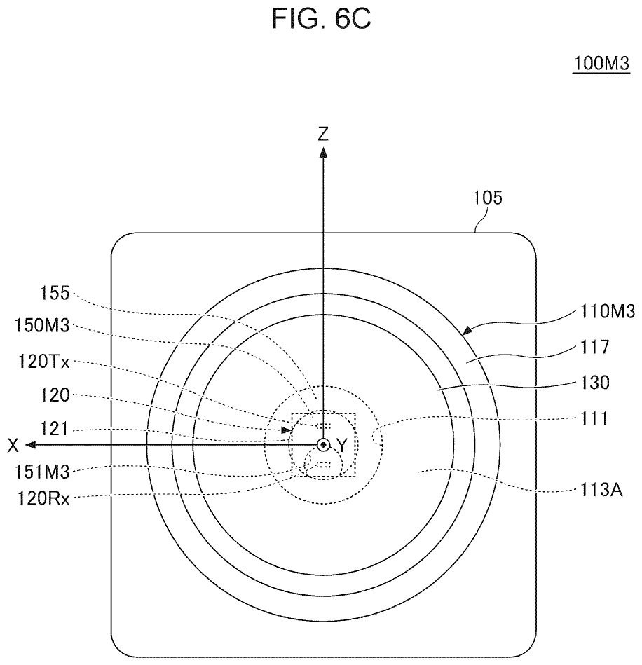

FIG. 6A to FIG. 6C are diagrams of an example structure of an antenna apparatus 100M3 according to a third modification of the embodiment. Here, differences between the antenna apparatus 100 and the antenna apparatus 100M3 will be described. Among the components of the antenna apparatus 100M3, the same reference numerals are given to components similar to those in the antenna apparatus 100 and their descriptions will be omitted.

### <Structure of Antenna Apparatus 100M3>

The antenna apparatus 100M3 has a structure in which the radio wave absorber 140 in the antenna apparatus 100 is omitted, a waveguide 110M3 is included instead of the waveguide 110, and a radio wave absorber 150M3 is fixed to the waveguide 110 using a holder 155, instead of the radio wave absorber 150.

### <Structure of Waveguide 110M3>

The waveguide 110M3 has the aperture 111, the aperture 112, a recessed portion 113A, an inner wall surface 114A, an inner wall surface 115A, and an inner wall surface 116A. A central axis of each of the aperture 111, the aperture 112, the recessed portion 113A, the inner wall surface 114A, the inner wall surface 115A, and the inner wall surface 116A is positioned on the central axis C.

The aperture 111 and the aperture 112 correspond to the apertures 111 and 112 of the waveguide 110.

The recessed portion 113A is provided in the aperture 111 on the −Y direction side and is a portion into which the holder 155 is fitted. The recessed portion 113A is a cylindrical portion that is recessed from a surface of the waveguide 110M3 on the −Y direction side to the +Y direction side. The central axis of the recessed portion 113A is aligned with the central axis C. The length of the recessed portion 113A in the radial direction is longer than the radius of the aperture 111. Accordingly, when the waveguide 110M3 is viewed from the −Y direction side in aperture view, the recessed portion 113A is larger than the aperture 111.

The inner wall surface 114A is a cylindrical wall surface (wall surface corresponding to an inner circumferential surface of a cylinder) having a constant diameter, and is connected to the +Y direction side of the aperture 111. The diameter of the inner wall surface 114A is equal to the diameter of the aperture 111.

The inner wall surface 115A is a wall surface (wall surface corresponding to an outer circumferential surface of a truncated cone) extending conically from an end of the inner wall surface 114A on the +Y direction side, and the aperture 112 is located at an end on the +Y direction side. The inner wall surface 115A is located outside the area represented by the angular aperture α represented by the equation (1). The inner wall surface 115A is located outside the first path P1 and the second path P2 illustrated in FIG. 2D.

The inner wall surface 116A is a cylindrical wall surface (wall surface corresponding to an inner circumferential surface of a cylinder) that is provided on the +Y direction side with respect to the aperture 112, and is larger than the aperture 112 in aperture view of the waveguide 110M3.

### <Structure of Radio Wave Absorber 150M3 and Holder 155>

The radio wave absorber 150M3 has a disc shape and has a through hole 151M3 that is located on the +Y direction side of the receiving antenna 120Rx. The through hole 151M3 extends through in the Y direction in about half of the radio wave absorber 150M3 on the −Z direction side. The through hole 151M3 has a cylindrical inner wall surface (wall surface corresponding to an inner circumferential surface of a cylinder) having a constant diameter.

The radio wave absorber 150M3 is, similarly to the radio wave absorber 150, for example, a component made by molding resin mixed with magnetic or dielectric powder or the like, and is a component that causes radio wave loss. The holder 155 is preferably non-metallic and comprises a dielectric. The holder 155 can be made of, for example, resin or ceramic.

In a state in which the radio wave absorber 150M3 is held by the holder 155, in aperture view of the waveguide 110M3, the radio wave absorber 150M3 covers the transmitting antenna 120Tx and enables the receiving antenna 120Rx to be exposed from the through hole 151M3. The inner wall surface of the through hole 151M3 is located outside the second path P2 illustrated in FIG. 2D. Accordingly, while the first direct wave that is output from the transmitting antenna 120Tx is attenuated by the radio wave absorber 150M3, the second direct wave that reaches the receiving antenna 120Rx passes through inside the through hole 151M3 and thus the second direct wave is not attenuated by the radio wave absorber 150M3.

The holder 155 is a disc-shaped component that is larger than the radio wave absorber 150M3, and has a recessed portion 155A formed along the central axis C from the −Y direction side and an aperture 155B that is provided on a +Y direction side of the recessed portion 155A. The recessed portion 155A and the aperture 155B are circular with the central axis C as the center when the holder 155 is viewed from the −Y direction side. The recessed portion 155A has a cylindrical inner wall surface (wall surface corresponding to an inner circumferential surface of a cylinder) having a constant diameter, and the aperture 155B that has a diameter smaller than that of the recessed portion 155A is continuous with an end on the +Y direction side. The recessed portion 155A and the aperture 155B extend through the holder 155 in the Y direction.

The radio wave absorber 150M3 is fitted into the cylindrical inner wall surface of the recessed portion 155A. In this state, in aperture view of the aperture 111 of the waveguide 110M3, the aperture edge of the aperture 155B is located outside the transmitting antenna 120Tx and the receiving antenna 120Rx. In other words, the aperture edge of the aperture 155B is located outside the first path P1 and the second path P2 illustrated in FIG. 2D.

As illustrated in FIG. 6A to FIG. 6C, the radio wave absorber 150M3 can be attached to the waveguide 110M3 by attaching the radio wave absorber 150M3 to such a holder 155 and fitting the holder 155 into the recessed portion 113A of the waveguide 110M3.

In the state in which the radio wave absorber 150M3 is attached to the waveguide 110M3, the radio wave absorber 150M3 is located inside the first path P1 of the first direct wave that is output from the transmitting antenna 120Tx, but is located outside the second path P2 of the second direct wave that reaches the receiving antenna 120Rx. Accordingly, the antenna apparatus 100M3 can provide high receiver sensitivity without attenuating the received wave while attenuating the transmitted wave using the radio wave absorber 150M3, and thus the antenna apparatus 100M3 with good radio wave receiver sensitivity can be provided.

In addition, in the antenna apparatus 100M3, the radio wave absorber 150M3 is attached to the waveguide 110M3, and thus the positioning accuracy of the waveguide 110M3 and the radio wave absorber 150M3 can be increased.

Note that the holder 155 is provided to hold the radio wave absorber 150M3 as described above, and the shape is not limited to the disc shape and may be various shapes.

While the antenna apparatus according to the exemplary embodiment of the disclosure has been described, it is to be understood that the disclosure is not limited to the embodiment disclosed specifically, and various modifications or changes may be made without departing from the scope of the claims.

What is claimed is:

1. An antenna apparatus comprising:
a board;
an integrated circuit chip comprising a transmitting antenna and a receiving antenna, the integrated circuit chip being mounted on the board;
a waveguide having a first aperture provided on the board side and surrounding the transmitting antenna and the receiving antenna in aperture view, a second aperture provided on a rear side with respect to the first aperture in a radiation direction of the transmitting antenna, and a first inner wall surface connecting the first aperture and the second aperture;
a radio wave lens fixed to the second aperture; and
a first radio wave absorber disposed on the first aperture side in a space surrounded by the first inner wall surface, wherein
at least part of the first radio wave absorber is located inside a first path of a first direct wave that is radiated from the transmitting antenna, directly reaches the radio wave lens, and passes through the radio wave lens, and
the first radio wave absorber is located outside a second path of a second direct wave that passes through the radio wave lens and directly reaches the receiving antenna.

2. The antenna apparatus according to claim 1, wherein the first radio wave absorber covers at least part of the transmitting antenna in aperture view of the first aperture.

3. The antenna apparatus according to claim 1, wherein the transmitting antenna and the receiving antenna are disposed across an optical axis of the radio wave lens.

4. The antenna apparatus according to claim 3, wherein the first radio wave absorber is provided on the transmitting antenna side with respect to the optical axis in aperture view of the first aperture.

5. The antenna apparatus according to claim 1, further comprising:
a cylindrical second radio wave absorber provided inside the first inner wall surface, wherein
the second radio wave absorber comprises
a third aperture that is provided on the first aperture side, is smaller than the first aperture and the board in aperture view of the first aperture, and surrounds the transmitting antenna and the receiving antenna;
a fourth aperture that is provided on the rear side with respect to the third aperture in the radiation direction and is larger than the third aperture; and
a second inner wall surface that connects the third aperture and the fourth aperture.

6. The antenna apparatus according to claim 5, wherein the second inner wall surface of the second radio wave absorber is located outside the first path and the second path.

7. The antenna apparatus according to claim 6, wherein the first radio wave absorber is integrally formed with the second radio wave absorber.
